(19) United States
(12) Patent Application Publication
(10) Pub. No.: US 2007/0194157 A1
(43) Pub. Date: Aug. 23, 2007

(54) Method and apparatus for high transfer efficiency electrostatic spray

(75) Inventors: Jeffry Golden, Creve Coeur, MO (US); Christopher G. Kocher, Belleville, IL (US); Matthew A. Hanlon, O'Fallon, MO (US)

Correspondence Address: HUSCH & EPPENBERGER, LLC, 190 CARONDELET PLAZA, SUITE 600, ST. LOUIS, MO, 63105-3441, US

(73) Assignee: Clean Earth Technologies, LLC, Earth City, MO (US)

(21) Appl. No.: 11/461,360

(22) Filed: Jul. 31, 2006

Related U.S. Application Data
(63) Continuation-in-part of application No. 10/632,891, filed on Aug. 1, 2003, now Pat. No. 7,150,412.
(60) Provisional application No. 60/401,563, filed on Aug. 6, 2002.

(51) Int. Cl. B05B 5/00

(52) U.S. Cl. 239/698; 239/690; 239/288

(57) ABSTRACT

A method of spraying an aerosol spray, comprising providing a grounded nozzle and an electrode separated by a predetermined distance; placing the electrode at a high electrical potential relative to the nozzle, thereby creating an electric field between the nozzle and the electrode; ejecting a liquid from the nozzle towards the electrode to atomize the ejected liquid into aerosol droplets or particles, so that in the applied electric field between the nozzle and the electrode the aerosol droplets or particles obtain an induced electric charge; and forming a directed spray of aerosol droplets or particles having a desired shape and with sufficient momentum and electric charge so that the directed spray of aerosol droplets or particles is deposited on a target.

### CROSS-REFERENCE TO RELATED APPLICATIONS

This application is a continuation-in-part of copending U.S. application Ser. No. 10/632,891 (incorporated by reference herein), filed Aug. 1, 2003, which in turn claims priority to U.S. Provisional Application No. 60/401,563 filed Aug. 6, 2002.

### STATEMENT REGARDING FEDERALLY SPONSORED RESEARCH OR DEVELOPMENT

This work was part of a project supported by the Technical Support Working Group under contract DAAD05-02-C-0017. The Federal Government retains Unlimited Rights, including the right to use, modify, perform, display, release, or disclose technical data in whole or in part, in any manner or for any purpose whatsoever, and to have or authorize others to do so in the performance of a Government Contract.

### BACKGROUND OF THE INVENTION

1. Field of the Invention

This invention relates to electrostatic-spray methods and apparatus, and in particular to methods of and apparatus for adding electric charges onto liquid to improve the transfer efficiency, also called the delivery efficiency, of the liquid particles onto target objects and to enhance the interaction of the liquid particles with airborne aerosol particles.

2. Related Art

There are numerous uses for spraying an electrostatically charged aerosol of electrically conducting liquid droplets for which high transfer efficiency is desirable and a high velocity spray of liquid droplets or air is not desirable. Such applications occur for the spraying of disinfectant liquids or decontaminants onto contaminated surfaces wherein it is desirable that the spray not dislodge the contamination so as to spread or aerosolize the contamination. Other applications are the spraying of liquid pesticide, fertilizer, or coating materials onto surfaces that are susceptible to damage by a high velocity spray of liquid droplets or air. Examples are found in agriculture, horticulture, animal care, and medicine.

Devices disclosed by others such as Sickles (U.S. Pat. Nos. 5,044,564 and 4,347,984) and Lasley (U.S. Pat. No. 4,934,603) employ air- or gas-assisted atomization in which compressed air or gas atomizes a liquid stream exiting a nozzle. Typically, the gas jet surrounds or is mixed with the fluid and is directed along the spray.

Often, induction charging is used to develop electric charge on the aerosol droplets. In this charging scheme, a high voltage (HV) potential is applied to either the spray nozzle or a nearby electrode or electrodes, and as the liquid stream breaks into droplets, electric charge remains on the droplets. The applied electric field can also enhance the atomization. The gas jet in such a situation may aid in reducing the number of charged aerosol droplets that reach the nearby electrode and comprise a leakage current that reduces the efficiency of the electrostatic charging. Moreover, the nozzle assemblies for such spraying often are intricate as both compressed gas and the liquid must be supplied to the spray nozzle. For spraying of viscous, high surface tension, or low conductivity liquids, such a spraying scheme can be very effective, for example for electrostatically spraying paint. However, for less viscous liquids and those of moderate or high electrical conductivity, such as aqueous based disinfectants, decontaminants, cleaning solutions, or fertilizers, such a scheme can produce a large proportion of small diameter droplets that may constitute a mist and do not transfer well to a target surface, and the backward attraction of such small droplets to the sprayer may present a safety problem for an operator if the sprayer is hand held, and the small droplets may coat the electrical insulation of the HV leads in the vicinity of the nozzle or electrode and result in arcing, current leakage, or an electrical short circuit.

Wang et al. (U.S. patent application Ser. No. 10/632,891, filed Aug. 1, 2003) in the parent of this application describe a method and apparatus for an electrostatic sprayer that does not require a compressed gas- or air-assisted nozzle. It works especially well with an ‘airless’ nozzle that produces a flat fan spray, hollow cone spray, or sheet spray of a liquid supplied by hydraulic pumping or a tube from a compressed gas pressurized liquid-containing reservoir. The sprayer employs an electrode to which a HV potential is applied and that has an opening through which the spray passes. The electrode is connected to a HV power supply by an insulated wire, i.e., a HV lead. The sprayer has a novel insulating cup to shield the HV lead from being electrically shorted by spray droplets. Further, Wang et al. describes the use of an electrically conductive housing for the sprayer so that the operator is protected from the HV electrode and so that backward attracted droplets are collected and safely electrically discharged.

Yet another feature of the sprayer described by Wang, et al. is that the spacing between the nozzle and the electrode is selected for optimum charging of the droplets in the spray. Also the opening of the electrode is selected for optimum charging and also for the electrical polarity of the spray droplets that exit the sprayer. When the opening is small so that the electrode is in very close proximity to the spray droplets, then the droplets transfer charge and become charged with the polarity of the electrode. When the opening is sufficiently and optimally wide, then the spray droplets have the polarity of the nozzle.

Although the sprayer of Wang et al. has demonstrated a high transfer efficiency, it has many features that can be improved upon for better performance, more rugged construction, easier and less costly fabrication, easier maintenance, and easier assembly. Such attributes can be especially important for hand held and portable sprayers and for sprayers that are mounted on vehicles or aircraft.

### SUMMARY OF THE INVENTION

Generally, according to the process of this invention, an electrode with high voltage is placed at a position near a grounded “airless” nozzle made from a conductive material, where the electrically conducting liquid is delivered to the nozzle by hydraulic pressure such by pumping or by connection to a pressurized reservoir. By an ‘airless’ nozzle what is meant is one that delivers substantially only liquid (apart from gases that may be dissolved in the ejected liquid) through the nozzle opening and which does not mix air with the liquid that is delivered through the liquid opening and which does not have air jets adjacent to the liquid-delivery opening of the nozzle. The liquid exits from the nozzle as a liquid stream that becomes unstable and breaks up into droplets. The direction along the central axis of flow is termed the axial direction. The transverse direction is orthogonal to the axial direction. The axial position of the electrode is chosen to be where the liquid has been atomized into separated particles, i.e., droplets, so to avoid electric current leaking through the connected liquid path to the grounded nozzle and so that the droplets carried induced charges as the droplets separate from the liquid stream. The electrode should not be so close to the liquid jet that the droplets in the fraction of the distribution of droplet size that comprise most of the mass in the spray impact the electrode and are lost to the spray exiting from the sprayer. Although it is most important that the electrode proximity to the spray be properly selected, for narrow streams, the electrode shape is not critical, e.g., the case of a ‘pencil’ spray between two electrode rods or passing through the opening in a planar electrode as described by Wang et al. However, for many spray patterns, and in particular sheet, flat-fan, and conical sprays, the shape of the electrode should be similar to the shape of the spray pattern. For example, an axisymmetric circular aperture electrode is used with a circular cone spray or circular hollow cone spray. As another example, an electrode assembly comprising two electrodes at the same potential, one on each side of a flat spray, is used with a flat-fan spray or a sheet spray. By so shaping the electrode, an approximately uniform distance between electrode and the spray of droplets around the flow can be made provided for electric charging of the largest fraction of the droplets in the spray. Additionally, the electrodes should have sufficient axial extent so that the droplets in the portion of the droplet size distribution that are of such small size that they have short stopping distances relative to the distance between the sprayer and the target surface will either impact the electrodes or the housing and be lost to the spray, or if the electrodes are in close proximity to the spray, these droplets can impact the electrodes, obtain a charging to the same polarity as the electrode, and be deflected back into the spray. In a preferred embodiment for a flat-fan or sheet spray, the electrodes are flat plates that are parallel with the plane of the fan or sheet spray. For a flat-fan spray, the electrode plates are segments of a circular annulus with the center of the circular arc being approximately at the exit of the nozzle so that all angular positions within the fan at a given radial distance from the nozzle are approximately adjacent to a corresponding axial position on the electrode plate.

In this process, the charge on the sprayed particles can have either a polarity that is opposite to the voltage, i.e., electrical potential, on the electrode or the same polarity as the voltage on the electrode according to the proximity of the electrode to the spray of droplets. When spraying a highly or moderately conductive liquid, according to a preferred embodiment of this invention, the electrode is mounted on a non-conducting electrode holder. An electrically conducting cable covered or coated with electrical insulation connects the electrode to the high voltage (HV) power supply. This cable is called the HV cable. The electrode holder is surrounded by or mounted on an electrically insulating concave cup. The open end of the cup is situated away from the direction of the spray so that the insulating cup maintains a dry surface either on a portion of the electrode holder or on its mounting to the sprayer so that a significant electric current will not leak from the electrode to a grounded surface via the wetted surfaces and cause a significant drop in the voltage on the electrode. Additionally, the HV cable either passes through a hole in the cup, as described by Wang et al., with means for sealing the interface between the cup and the insulation of the HV cable, e.g., sealant glue, or the HV cable passes around the side of the cup and then into the cup interior so that a portion of its insulation remains protected from spray and maintains a sufficiently dry surface to prevent unacceptable electrical leakage current or an electrical short circuit.

The electrode and nozzle are contained within a housing that has an exit hole or slot through which the directed spray exits. The housing protects the operator or other persons from inadvertently contacting the high voltage electrode and that also provides a means of collecting small diameter charged particles that can be attracted back to the sprayer. The housing may be of electrically conductive, e.g., metal, or resistive material, e.g., conductive plastic, or it may be covered either entirely or in part by a conductive or resistive film, coating, tape, or wires. As the spray of droplets exit the sprayer housing, those particles with insufficient velocity to travel to a target surface may be attracted back to the sprayer. These droplets are termed backspray. Because of the conductivity of the liquid, a very slight partial coating of the housing by the backspray can make the housing sufficiently conducting so that a path to ground is provided and the charges of the droplets of the backspray deposited on the housing will be carried to ground. In a preferred embodiment, the housing is made of plastic and covered with resistive tape around part of its exterior surface on each side of the exit slot of the housing. The tape makes contact with a wire that electrically connects to the ground connection of the nozzle.

The spray, which is electrostatically charged, exits from the sprayer with momentum directed at a target. The electric ‘space-charge’ of the charged particles in the spray induces image charges in nearby conducting objects. If the target is conducting and grounded, then the spray is attracted to the target as well as carried by its momentum as it encounters the drag force associated with the viscosity of the air. For a non-conducting target, the initial deposition of spray having sufficiently low resistivity may change the non-conducting target surface into a conductive one. If there is an adjacent ground, then the non-conducting target may then act as a conducting target.

Furthermore, the target also may be at a potential that is different from ground and the electrode in the sprayer. In this manner, the associated applied electric field can act in concert with the directed momentum and the image force to attract the sprayed particles onto the target.

In the preferred embodiments of this invention, the high voltage is generated with an un-regulated, low-power, typically less than 5 W, converter that converts a low-voltage, e.g. 0-15 V, DC input into a high-voltage, e.g. 1-20 kV, DC output. In a preferred embodiment, the potential applied to the electrode is in the range of 8-12 kV.

The spray nozzle can be any airless gun where the liquid is atomized by the hydraulic pressure, provided that the spray nozzle is electrically conductive and grounded. In a preferred embodiment, the nozzle produces a flat-fan or sheet spray. Instability of the liquid jet exiting from such a nozzle causes transverse oscillations that lead to jet breakup into droplets in a short axial distance. Instabilities may include flapping (“flag”) modes, longitudinal modes, and transverse “rolling” modes. Such jet breakup can provide sufficient transverse velocity to the smaller droplets in the spray so that they may be removed from the principal part of the spray. The nozzle can be mounted on a hand held spray gun, which can be electrically conductive or insulating. The spray gun may have an on-off valve. The electrical connection between the nozzle and ground can be achieved with an electric wire or simply through the liquid path, if the liquid's resistivity is not very high. The electrostatic spray gun in this invention is safe because the spray gun and the liquid path are grounded and, when a short circuit occurs, the output voltage of the converter will quickly drop to the same level as the input to avoid electric shock.

In an alternative embodiment, multiple nozzles are mounted on a single manifold so that the liquid is sprayed simultaneously from the multiple nozzles. A single electrode assembly is positioned at an optimal location. The electrode may be shaped to accommodate the various angular orientations of the flow from the nozzles. In a preferred embodiment with multiple nozzles forming a co-planar array, the assembly comprises two electrodes, each a flat metal plate that is parallel to the plane of the sprays and having a curved shape so that each spray has a similar geometrical aspect to the electrodes.

Surrounding the manifold, nozzles, and electrode is a housing that has the electrical properties described above and that also has an opening so that the sprayed particles can exit the assembly with minimal interception of particles from the spray by the housing.

Because this electrostatic method can be applied with most of the existing commercial non-electrostatic spray guns, and because the cost of adding an electrode and an unregulated low-power converter is relatively low, the electrostatic method in this invention is much more economical than those currently available.

Accordingly, in one embodiment the invention is a method of spraying an aerosol spray, comprising providing a grounded nozzle and an electrode separated by a predetermined distance; placing the electrode at a high electrical potential relative to the nozzle, thereby creating an electric field between the nozzle and the electrode; ejecting a liquid from the nozzle towards the electrode to atomize the ejected liquid into aerosol droplets or particles, so that in the applied electric field between the nozzle and the electrode the aerosol droplets or particles obtain an induced electric charge; and forming a directed spray of aerosol droplets or particles having a desired shape and with sufficient momentum and electric charge so that the directed spray of aerosol droplets or particles is deposited on a target.

In another embodiment the invention is an airless electrostatic sprayer for spraying aerosol particles, comprising at least one electrically conductive, grounded nozzle; a pressure source to force fluid through the nozzle wherein the exiting fluid forms a stream of aerosol particles or droplets; and an electrode with high electric potential disposed at a distance from the nozzle and from the stream of aerosol particles or droplets, wherein the electric potential creates an electric field that charges the stream of aerosol particles or droplets; wherein the electrode is placed sufficiently far from the stream of aerosol particles or droplets so as to induce a charge on the particles or droplets that is of the opposite polarity as the potential on the electrode.

In yet another embodiment the invention is an airless electrostatic sprayer for spraying aerosol particles, comprising at least one electrically conductive, grounded nozzle; a pressure source to force fluid through the nozzle wherein the exiting fluid forms a stream of aerosol particles or droplets; and an electrode with high electric potential disposed at a distance from the nozzle and from the stream of aerosol particles or droplets, wherein the electric potential creates an electric field that charges the stream of aerosol particles or droplets; wherein the electrode is placed sufficiently close to the stream of aerosol particles or droplets so as to induce a charge on the particles or droplets that is of the same polarity as the potential on the electrode.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a block diagram of the apparatus of the electrostatic sprayer system;

FIG. 2 is a block diagram of the electrostatic sprayer system wherein the liquid is supplied by a pressurized reservoir;

FIG. 3 is a schematic of a flat-fan sprayer with an electrode assembly comprising two annular segment shaped flat plate electrodes;

FIG. 4 is a schematic of a hollow cone sprayer with a conical annular ring electrode;

FIG. 5 is a schematic of a preferred embodiment of electrostatic sprayer that produces the opposite polarity charged spray as the HV electrode polarity;

FIG. 6 is a schematic of a preferred embodiment of electrostatic sprayer that produces the same polarity charged spray as the HV electrode polarity;

FIG. 7 is a schematic of the electrode mounting and HV cable that are surrounded by a concave cup;

FIG. 8 is an exploded view of the electrode mounting and insulating concave cup;

FIG. 9a is a view from the nozzle side of the electrode assembly, its mounting, and the insulating concave cup;

FIG. 9b is a view of the assembly with one of the electrodes removed and shows the HV cable;

FIG. 10 is an interior view of the sprayer with the housing opened up;

FIG. 11 is a view of the sprayer when looking toward the nozzle;

FIG. 12a is a view of the sprayer showing the exit slot from which the electrostatic spray emerges;

FIG. 12b is a view of the sprayer showing the back of the housing and connections;

FIG. 13 is a photograph of a preferred embodiment of the electrostatic sprayer;

FIG. 14 is a photograph of a preferred embodiment of the sprayer with the housing opened to show the electrode assembly, the spray nozzle, and the spray gun;

FIG. 15 is a photograph of a preferred embodiment of the sprayer showing the assembled housing, the resistive tape on the exterior of the housing, the wires and the connection for the liquid supply;

FIG. 16 is an alternative embodiment of an electrode for a sprayer; and

FIG. 17 shows cross-sections of various embodiments of the electrode shown in FIG. 16.

### DETAILED DESCRIPTION OF THE PREFERRED EMBODIMENTS

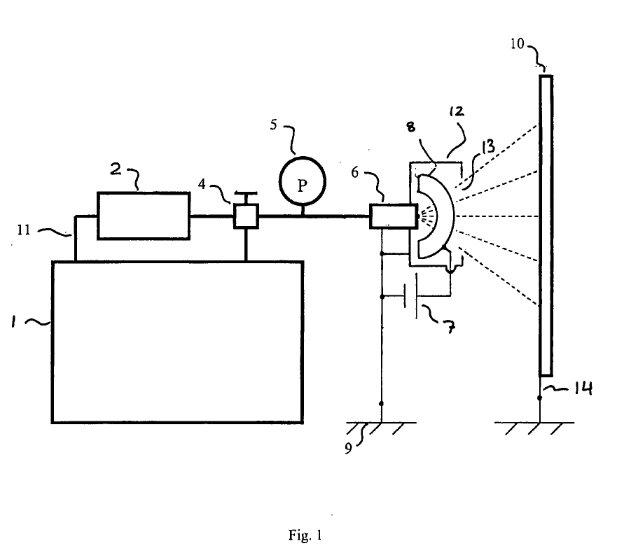

An apparatus, an electrostatic spraying system, for electrostatic spray in accordance with the principles of the present invention is illustrated schematically in FIG. 1. The liquid or particles to be sprayed are contained in reservoir 1, which is connected by a tube 11 to a pump 2. The spray pressure is controlled by a regulator 4 and displayed by a pressure gage 5. The spray gun 6 is an integration of a valve, a connection for liquid supply, and a nozzle from which a liquid jet emanates and then disintegrates, i.e., liquid jet breaks up and separates into particles (droplets). The electrostatic charge is induced from the ground 9 through the spray gun onto the particles by the high voltage on the electrode assembly 8. The high voltage is generated by a high-voltage (HV) converter 7 which converts a low voltage DC signal into high-voltage DC output. The HV potential can be either positive or negative polarity. The particles are sprayed toward a target object 10, e.g. a wall or vehicle, where the charge on the particles is conducted back to ground 9 by a path 14 that may be a direct electrical connection, or electrical contact with a grounded object, or by a surface conduction path, which may be via a partial surface film or coating of conductive liquid. The sprayer is enclosed in a housing 12 that has an exit opening 13 for the electrostatic spray.

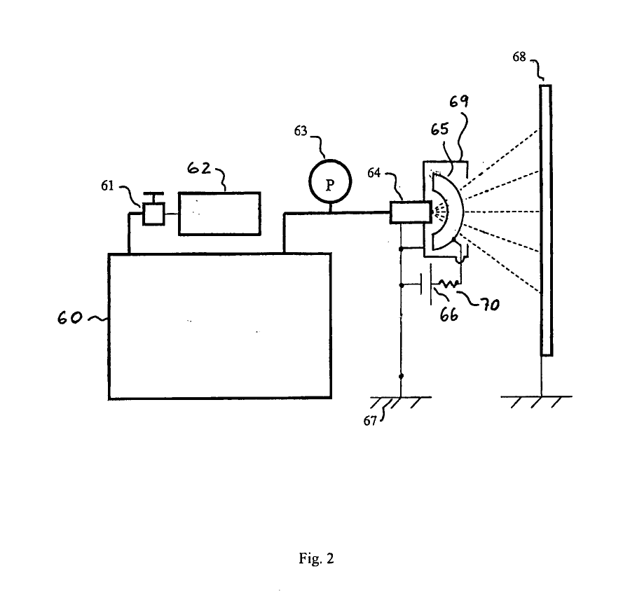

As shown in FIG. 2, when a lightweight electrostatic spray system is preferred, the liquid in the reservoir 60 can be pressurized with compressed air from a high-pressure vessel 62. By using a regulator 61 to adjust the output pressure of the compressed air, one can control the spray pressure, displayed on the pressure gage 63, and the corresponding flow rate in a wide range. Also shown in the figure are the spray gun 64, the electrode assembly 65, the housing 69, the HV power supply 66, a current limiting resistor 70, and the target surface 68.

Because the density of air is very low, even at high pressure, one can store a sufficient amount of compressed air at a high pressure, e.g. to 4,500 psi, in a commercially available re-chargeable composite high-pressure vessel that is very light weight. For safety and reliability, both the liquid reservoir and the compressed-air vessel must meet the ASME specifications for high-pressure vessels. Also for safety, a current limiting resistor or resistors 70 can be placed in series with the power supply and the electrode. The value of the resistance should be small enough so that adequate current can flow into the sprayed droplets, but large enough so that the hazard of dangerous electrical shock to a person is mitigated. In a preferred embodiment, a resistance value of 100 mega-Ohms is sufficient to limit the current to approximately 0.120 mA when the applied voltage is 12 kV.

The electrostatic apparatus in this invention is adaptable for spray guns with hydraulic supply of liquid with moderate or low electric resistivity and for “airless” spray nozzles. Generally, a spray gun with a spray nozzle made with electrically conductive material is required. The nozzle must be connected to ground with an electric cable or through the fluid path, if the fluid is conductive. If the spray-gun body is also conductive, the ground cable can also be connected to the spray gun. By an ‘airless’ nozzle what is meant is one that delivers substantially only liquid (apart from gases that may be dissolved in the ejected liquid) through the nozzle opening and which does not mix air with the liquid that is delivered through the liquid opening and which does not have air jets adjacent to the liquid-delivery opening of the nozzle.

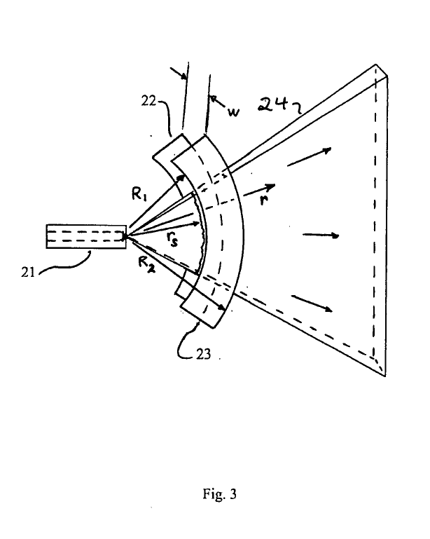

The profile of the electrode should cover the complete periphery of the sprayed patterns of the particles to maximize the electrostatic charges. As shown in FIG. 3, the droplets in a flat-fan spray pattern 24 can be charged with a pair of flat electrodes 22, 23, one on each side of the fan, each electrode being shaped as a segment of a circular annular plate. The center of curvature for the electrode should be approximately at the axial position of the nozzle 21. In the following description, the distance from the center of the nozzle orifice is denoted as the radial position, r. The radial distance R₁ from the edge of the annular electrode to the nozzle should be at a radial position that is approximately the same as the distance from the nozzle of the position within the liquid flow where the liquid jet is breaking up and liquid droplets are separating from the jet to form the spray of droplets. This position of separation is termed the separation point, and is denoted as rₛ. Because the breakup of the jet typically is the result of instability in the flow, the distance of the breakup, where the flow is not contiguous, and the separation point, rₛ, will be unsteady, i.e., will vary in time, and be a functions of the Weber number,

$$We = \frac{{ρ}_{l ,} {v}^{2} δ}{γ} ,$$

where ρ_{L} is the density of the liquid, ν is the velocity of the stream, γ is the surface tension, and δ is a typical dimension, e.g., the radius of the jet or the half-thickness of a sheet or flat-fan jet. For divergent flows, δ is a function of position along the flow, typically varying as 1/r. As ν depends on the pressure p₀ of the liquid supply to the nozzle, the nozzle geometry and the orifice size, Wₑ will be a function of p₀. Accordingly, the electrode should be positioned and R₁ selected to accommodate the lowest value of p₀, and correspondingly the lowest ν, for the range of anticipated operating pressures. The annular thickness of the electrode, ΔR=R₂−R₁ should be selected so that at the highest operating pressure, and correspondingly highest ν, the separation point occurs at a position closer to the nozzle than R₂, i.e., rₛ<R₂. As described further below, there are additional considerations in the selection of R₂ that may influence the polarity and charge density, i.e., the charge per volume, induced on the droplets and also influence the leakage currents and charging efficiency of the sprayer.

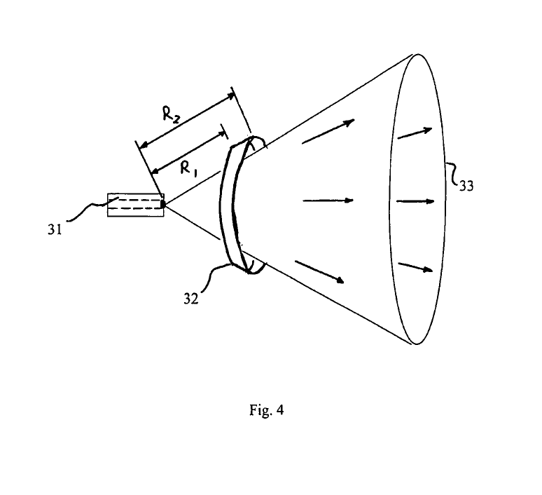

For a circular-cone spray pattern 33 produced by nozzle 31, as shown in FIG. 4, an axisymmetric electrode 32 that is a metal ring or annular segment of a cone can provide the appropriate electric field for inducing charge on the spray droplets. In this case, the criteria for selection of R₁ and R₂ are the same as in the flat-fan case.

The selection of the spacing of the electrode from the principal part of the flow of droplets affects the polarity of the induced charge on the droplets, the charge density, the leakage current, and the charging efficiency of the sprayer. The principal part of the spray, i.e., the flow of droplets, is that part containing the preponderance of mass, and so is that part of the distribution f(d) of droplet diameter d that includes the larger particles. As the mass and droplet volume are proportional to d³, it is not unusual for smaller droplets to be more numerous in the spray but represent a small fraction of the mass. As a usual goal of the spraying is to obtain high transfer efficiency η to a target, it is the delivery of the principal part of the spray that makes the greatest contribution to η. However, the dynamics of the smaller droplets within the sprayer housing can greatly affect the electrical charging of the spray. After exiting the sprayer housing, the smaller droplets can produce a backspray that may affect the safety, convenience, or usefulness of the sprayer.

Larger droplets are less slowed by aerodynamic drag than smaller droplets. For an initial velocity v₀ and for droplets with diameter in the range 10 μm <d<1 mm, the stopping distance S in a gas (e.g., air), [see, for example, W. C. Hinds, Aerosol Technologies Aerosol Technology: Properties, Behavior, and Measurement of Airborne Particles] when gravity and electrostatic forces are ignored, is given approximately by

$$S = \frac{{ρ}_{L} d}{{ρ}_{g}} [ {Re}^{1 / 3} - \sqrt{6} arc tan ( {Re}^{1 / 3} / \sqrt{6} ) ] , \qquad ( 1 )$$

Where ρ_{g} is the mass density of the gas,

$$Re = \frac{{ρ}_{g} vd}{υ}$$

is the Reynolds number, and ν is the viscosity of the gas. The flow velocity v₀ can be estimated for a given flow rate Γ and nozzle orifice diameter d₀ from the relation

$$Γ = \frac{{v}_{0} π {d}^{2}}{4} .$$

For Γ=8.5 ml/s (˜0.51 liters per minute) and d₀=0.6 mm, the velocity is v₀≈30 m/s. Table I shows S as calculated by Equation 1 for various diameter droplets with v₀≈30 m/s.

TABLE I
Approximate stopping distance for various diameter
droplets in air with initial velocity v₀ ≈ 30
m/s without effects of gravity or electrostatics.

| d(μm) | Re | S(m) |
|---|---|---|
| 10 | 19.9 | 5.5 × 10⁻³ |
| 30 | 59.7 | 0.036 |
| 50 | 99.5 | 0.082 |
| 100 | 199 | 0.247 |
| 300 | 597 | 1.32 |
| 500 | 995 | 2.80 |

Gravity and electrostatics affect the dynamics. Settling due to gravity is non-negligible for large droplets. For droplets with d=500 um, the terminal settling velocity is approximately 2 m/s. The electrostatic electric field E has a greater effect on smaller droplets. The size of the electrostatic effect depends on the charge density induced on the droplet. Taking the Rayleigh limit at which electrostatic repulsion overcomes surface tension forces, the limiting charge on a droplet would be q_{R}=[2πγd³/K_{E}]^{1/0.2}, where K_{E}=9×10⁹ in SI units. For Re>1, and for a droplet of diameter d, charge q, and drag coefficient C_{D}, the terminal drift velocity resulting solely from the electric field can be determined by the following procedure. The quantity C_{D}Re² can de calculated by Equation (2),

$${C}_{D} {Re}^{2} = [ \frac{8 q E {ρ}_{g}}{π {υ}^{2}} ] , \qquad ( 2 )$$

and C_{D}Re² can be determined from well known tables [for example, see W. C. Hinds, Aerosol Technology: Properties, Behavior, and Measurement of Airborne Particles, Section 3.7]. Using this procedure, and assuming q=q_{R} and the surface tension of water, the drift velocity V_{d} for various diameter droplets in an electric field E=10 kV/m are calculated and shown in Table II.

TABLE II
Drift velocity vs diameter in an E = 10 kV/m electric field.

| d(μm) | v_{d} (m/s) |
|---|---|
| 10 | 1.24 |
| 30 | 1.77 |
| 50 | 2.0 |
| 100 | 2.25 |
| 300 | 2.42 |

For the example given above, in comparison with the initial spray velocity v₀≈30 m/s, it is seen that the increment to velocity because of electrostatics will mainly affect larger droplets near the end of their stopping distance. In contrast, the electrostatics can overcome that short stopping for small droplets although v_{d}<<v₀. Thus, the electrostatics can cause intermediate and small particles to travel to a target surface, which can aid in achieving thorough coating of the target. Moreover, as the smaller and intermediate size droplets will track the electric field lines of force, non-line-of-sight coating of the target can be obtained. These are well known benefits of electrostatic spraying. However, the short stopping distance without electrostatics and the dominance of electrostatic effects for intermediate and small droplets can have great consequence in the charging of the principal part of the spray within the sprayer.

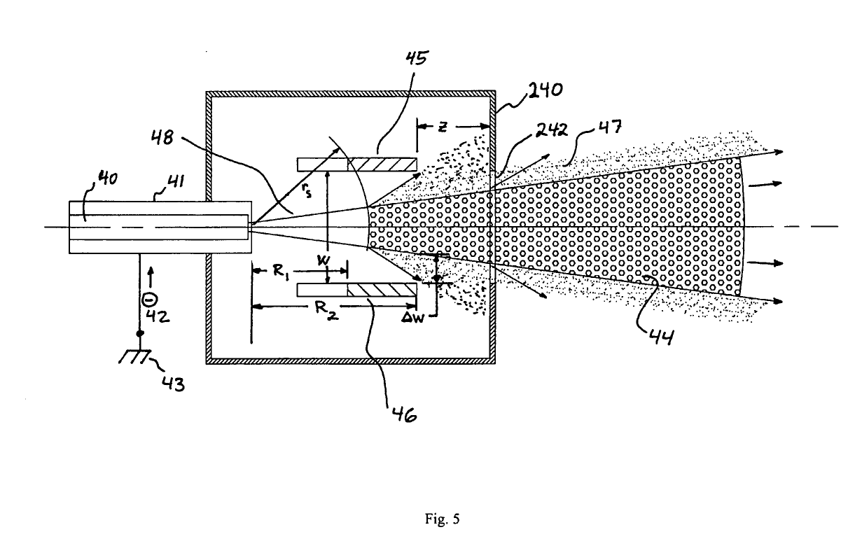

In the configuration shown in FIG. 5, the electrodes 45, 46 are positioned at a distance Δw from the principal part of the spray so that the droplets 44 emerging from the sprayer have the same charge polarity as the grounded nozzle 41, i.e., opposite to the polarity of HV applied to electrode. For a positive electrode, the current flows from the nozzle to ground 43 as negative charges 42 must be supplied to the liquid jet. The conductive liquid 40 supplied hydraulically to the nozzle is at ground potential. The nozzle and electrodes are enclosed within a housing 240 that has an exit opening 242 through which the spray emerges from the sprayer.

It is usually desired that the highest charge be induced on the droplets, that the leakage current be minimal, and that the spacing of the HV parts from ground be sufficient to avoid arcing or an electrical short circuit. Because the induced charge q is related to the capacitance C of the separating droplet and the voltage on the electrode V as q=CV, and the capacitance increases as the spacing from the droplet to the electrode is reduced, q can be maximized by reducing Δw as much as possible. A constraint on how small Δw can be is that the leakage current increases as the spacing is reduced. Also, the danger of an electrical arc via the droplets to the liquid jet or the nozzle increases.

The small and intermediate droplets in the spray play an important role in the leakage current. It is found in our measurements, that the induced charge is relatively independent of Δw for a broad range. However, as Δw is made smaller than a critical value, the induced charge decreases and the leakage current increases. This can be explained by deflected small and intermediate droplets 47 that are ejected from the principal spray and that move toward and intercept an electrode plate if it is too near. The small, e.g., d<30 μm, and intermediate, e.g., 30 μm <d<100 μM, size droplets are slowed by drag relative to the larger droplets that have most of the mass. Collisions between large droplets and those of intermediate and small size will lead to deflection of the intermediate and small droplets out of the principal spray. Collisions with low

$$We = \frac{2 {ρ}_{l} , Δ {v}^{2} {d}_{1}}{γ} ,$$

where Δv is the relative velocity between droplets, and d₁ is the diameter of the larger droplet, will not lead to droplet coalescence or disintegration. Additionally, if the ejected droplets have Wₑ<7 and especially near unity, then such droplets can bounce off the electrode, and depending on Δw, return to the principal spray and collide with other droplets. Droplets that collide with and bounce off the electrode can undergo charge transfer and leave the electrode with a charge as the same polarity as the electrode. Collisions by such droplets with the principal spray droplets result in a reduction in the charge in the principal spray. Although most of the deflected droplets do not reflect from the electrode, but instead wet the electrode or, if We is sufficiently large, disintegrate into small droplets that do not return to the principal spray, sufficiently many droplets do bounce off the electrode to affect the principal spray when Δw is small enough. Furthermore, for flat-fan, hollow cone, and sheet sprays, the liquid jet 48 undergoes modes that lead to instability, breakup, and separation. Such modes include transverse modes such as flapping (“flag”) motion, “rolling” and tearing modes that can have high vorticity transverse to the mean flow direction. As a consequence, droplets in these thin layer sprays will have substantial transverse velocity that results in spread of the spray, i.e., divergence perpendicular to the sheet (planar or conical) or fan. In a preferred embodiment, a flat-fan producing nozzle is used. One such nozzle is a Unijet Nozzle Model No. 730154 (Spraying Systems Co.), which has a 0.6 mm diameter orifice and a stainless steel body. With p₀ in the range 30-90 psig, a fan with an angular width of θ˜57 degrees in the plane of the fan is produced with a flow rate Γ˜0.5 liters per minute. Jet breakup leads to a separation point rₛ [symbol] 2 to 3 cm. Fan divergence perpendicular to the plane of the fan amounts to an angular width φ˜15 degrees. Accordingly, the electrode has R₁=1.25 cm, R₂=3.327. The electrode is made of 6.3 mm thick aluminum alloy plate. The electrode comprises an annular segment of slightly less than 180 degrees. All electrode edges have a radius of 1.5 mm, and the surface is finished to 63 microinches. In a preferred embodiment, the electrode spacing is w=1.59 cm. It is estimated that Δw≈4.6 mm. In tests it is found that charging efficiency does not appreciably change for w in the range 1.5 to 3 cm. Charge efficiency decreases with larger values of w.

The housing 240 shown in FIG. 5 has part or all of its exterior surface covered or coated with a conducting surface. Backspray that is deposited on the exterior of the housing. Errant spray is deposited on the interior of the housing. Consequently, the housing is resistively connected to ground and charge deposited on the surface is drained to ground. The housing must be sufficiently far from a HV electrode so that arcing does not occur. In a preferred embodiment, the housing is made of plastic, has a wall thickness of 3 mm, the minimum spacing z between electrode housing along the spray is approximately 1.5 cm for an applied potential of 10 kV.

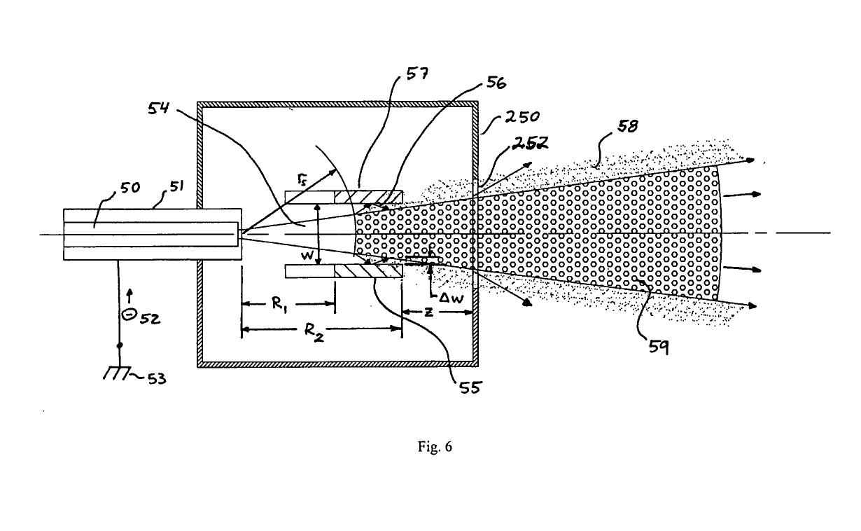

An embodiment is shown in FIG. 6 wherein the spray has the same polarity as the HV electrode. A grounded nozzle 51 is supplied with liquid 50. For positive HV electrodes 55 and 57, current 52 flows from the nozzle 51 to ground 53. Electrodes 55 and 57 are positioned with R₁ and R₂ as described above. The nozzle and electrode(s) are enclosed in a housing 250 that has an exit opening 252. The liquid jet 54 breaks up and droplets separate at r=rₛ. Some droplets are ejected from the principal spray. However, in this embodiment, Δw in the vicinity of R₂ is reduced to a mm or two. Small and intermediate size droplets 56 will strike the electrode, become charged with the same polarity as the electrode, and return to the principal spray 59 with the result that the principal spray 56 exiting the sprayer carries charge of the same polarity as the electrode. In this case, some of the larger droplets may also strike the electrode. However, if Wₑ is near unity, the droplet typically will remain intact but be deflected back to the principal spray. Collisions between large droplets at such low Wₑ do significantly change the droplet size distribution.

Because the atomization depends very much on the nozzle design, the spray pressure and the liquid's properties, the optimal position between the electrode and the nozzle can be determined by experiment. An example of such an experiment is the measurement of the average charge density on a particle, i.e., the mean of the ratio of the electric charge and the particle volume, the ratio being a function of electrode position and the width of the electrode opening. Another such experiment is the determination of the ratio of the sprayed electrical current and the sprayed volumetric flow rate that exits the sprayer apparatus, this ratio being another indication of typical charge density on a particle and being a function of the electrode position and width of its opening.

The high voltage converter used in a preferred embodiment is an EMCO No. E121. This converter is powered by 12 VDC from a multi-cell battery pack. The 10 kilovolt output is connected to the electrode by a high voltage insulated cable rated at 15 kilovolts. The converter is potted, i.e., embedded in plastic, inside of a grounded aluminum housing. An on-off switch is mounted into the housing and connected to the input of the converter.

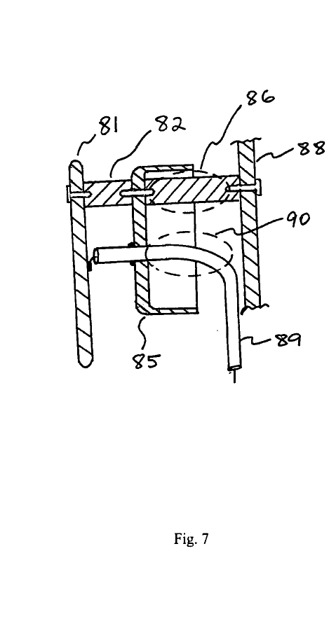

The presence of a deflected spray of fine droplets in the vicinity of the electrode assembly can wet electrical insulating surfaces and lead to unacceptable leakage current or an electrical short circuit. This especially can be a problem when spraying liquid of high or moderate electrical conductivity. Wang et al. described the use of a concave cup surrounding the HV cable and part of the mounting for the electrode assembly to maintain a relatively dry portion of insulation and so avoid the leakage or short circuit problem. Such a configuration is shown in FIG. 7. An electrode 81 is held on an electrode mounting 82 that is surrounded by a concave cup 85 of insulating material that maintains dry portions 86 and 90 of insulation on the mounting to the housing 88 and the HV cable 89. This means has been shown to work well to avoid HV electrical problems, however, the need to pass the HV cable through an opening in the concave cup and to seal the crevice between the cable and the cup to prevent liquid from wetting the protected portion of insulation pose potential assembly and maintenance issues.

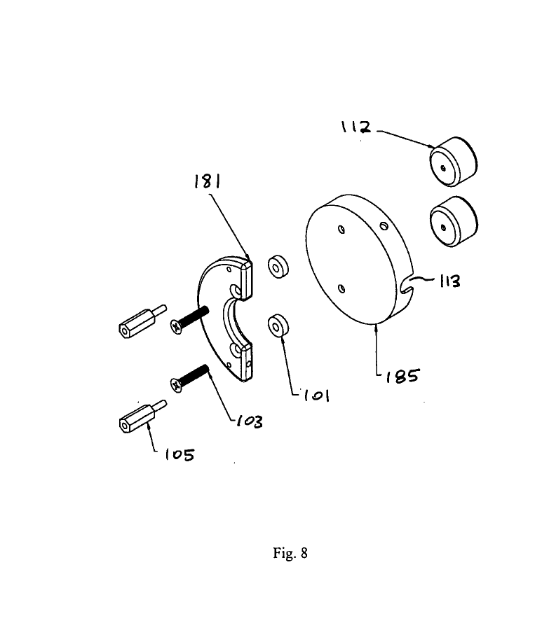

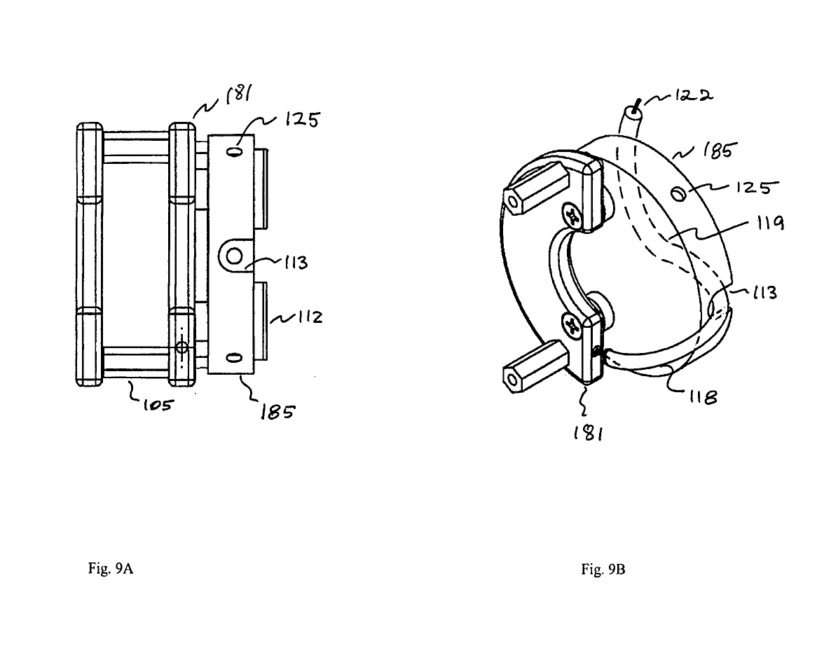

An improved means of protecting the electrical insulation from the errant spray within the housing is shown in FIGS. 8 and 9. In this means, the HV cable 118 is attached to the electrode 181 and then positioned to pass behind and into the insulating concave cup 185, which forms a protective shield to maintain a dry portion 119 on insulation on the HV cable. An electrode 181 is separated from an insulating concave cup 185 by spacers 101 and fastened by screws 103 that pass through openings in the cup 185 and part of commercially available sealing devices 112 comprising a silicone bushing and a silicone sealing cap that allow a nut to be screwed onto each screw 103. A second part of the sealing device 112 is attached over the first part of the device 112 to form a liquid tight seal. The seal also prevents liquid from entering the interior of the concave cup from the electrode side. Attached to the electrode may be conducting standoff spacers 105 on which another electrode can be fastened to form the electrode assembly. FIG. 9a shows the assembled electrode assembly and its mounting to the concave cup 185. In a preferred embodiment, the cup has an outer diameter of 6.35 cm, a wall thickness of 1.5 mm, and it is made of Teflon. In the preferred embodiment, a slot 113 is provided for the HV cable to pass into the cup interior. The spacers 101 may be made of either conducting or insulating material. In a preferred embodiment, the spacers are made of nylon. Also in a preferred embodiment, the end of the cable 122 not attached to the electrode is attached to the HV supply via two series resistors with a combined resistance of 200 mega-Ohms. Holes 125 are provided for attaching the cup to insulating mounting posts on the housing of the sprayer that protrude into the concave interior of the cup. The cup is situated to also maintain a dry portion on the mounting posts.

The housing for the sprayer prevents inadvertent human contact of the parts at HV potential. It also encloses the errant spray and allows the liquid from such spray to be collected or directed to drip from an opening in the bottom of the housing. Wang et al. teaches the benefits of a conducting housing or cover. However, manufacture of a conducting housing made of conductive polymer can be expensive. A metal housing would be heavy and may also be expensive to fabricate. It is found that the benefits of a conductive housing also can be obtained with a housing made of insulating material that is either covered entirely or in part on its exterior by a conductive or resistive coating, wires, screen, tape, or metal film. In a preferred embodiment, the housing has two halves and is made of black, non-conducting TIVAR 1000 UHMW polymer. This material is easily machined and is corrosion resistant, strong, and lightweight.

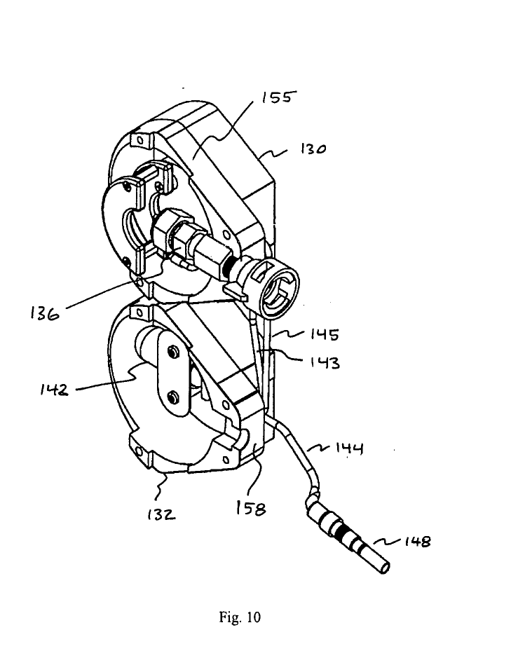

FIG. 10 shows an interior view of the housing halves 130,132 and the mounted nozzle 136, the electrode assembly mounted on the insulating cup, an insulated wiring harness 142 that includes the two series resistors connected to the HV cable 144 and 145, and a HV connector 148 on the end of the HV cable as a removable attachment to the HV power supply. In a preferred embodiment, resistive antistatic polymer tapes 155, 158 are wound around a portion of each half of the housing and connected to metal tabs that are in turn connected to a ground wire 143 that connects to the grounded nozzle 136. In this way, backspray discharging and an electrically safety cover are provided.

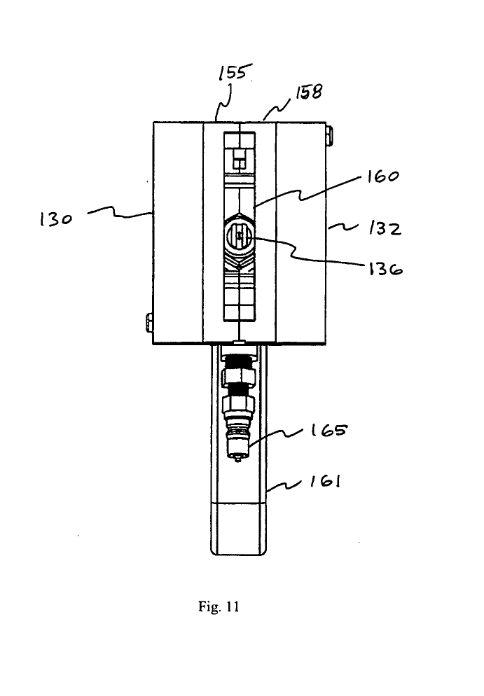

FIG. 11 shows a view of the sprayer looking toward the nozzle 136. Shown are the two halves of the housing 130, 132, the resistive tape 155, 158, a spray exit opening comprising a slot 160 in the housing, a commercially available spray gun 161, and a connector 165 for attachment to the liquid supply. In a preferred embodiment, the spray gun is a modified type AA30L-PP that is manufactured by Spraying Systems Company and is made of nylon. The connector is a “quick” connector, and the liquid supply is via a hose that has a mating connector. The exit opening of the housing has a width of 1.59 cm to permit the spray to exit the assembly with minimum interception and also to reduce the likelihood of inadvertent insertion of a finger into assembly and contact with the high voltage electrode. The housing also acts to capture and contain errant spray within the housing. In a preferred embodiment, the housing has slots at the top and the bottom to permit the captured spray to drip from the housing and not significantly accumulate within.

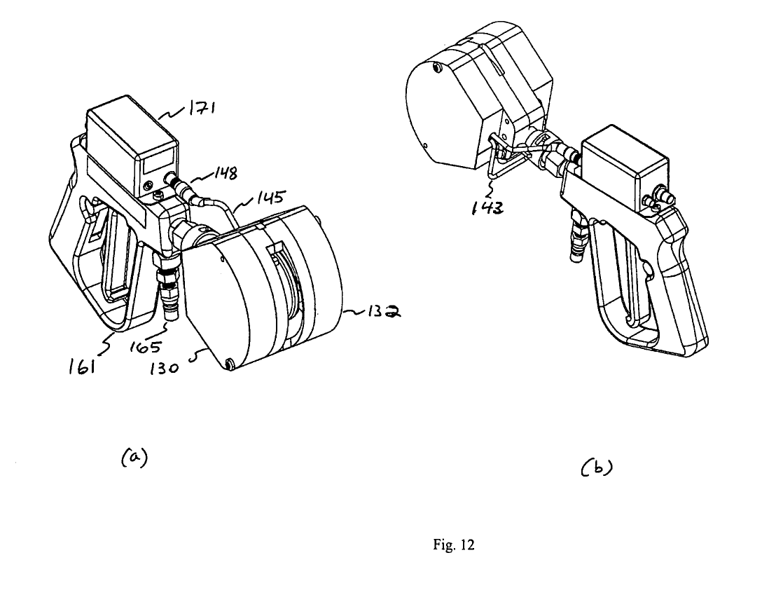

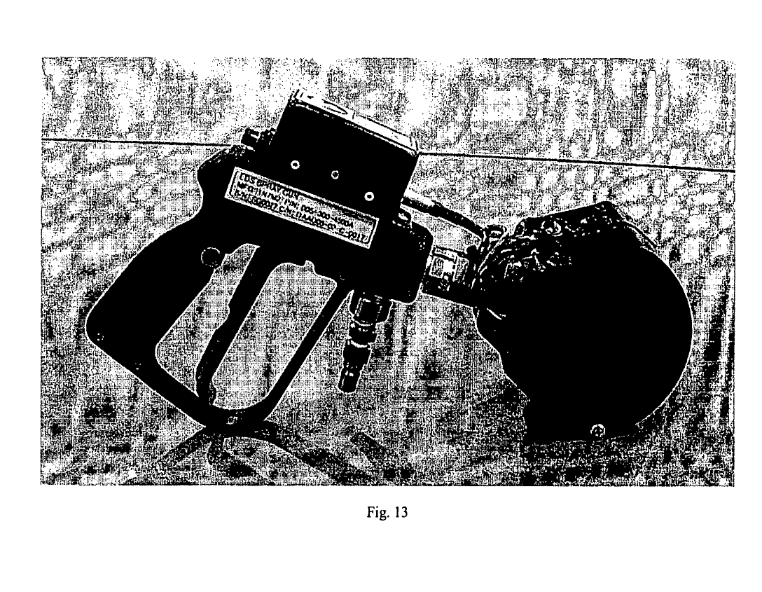

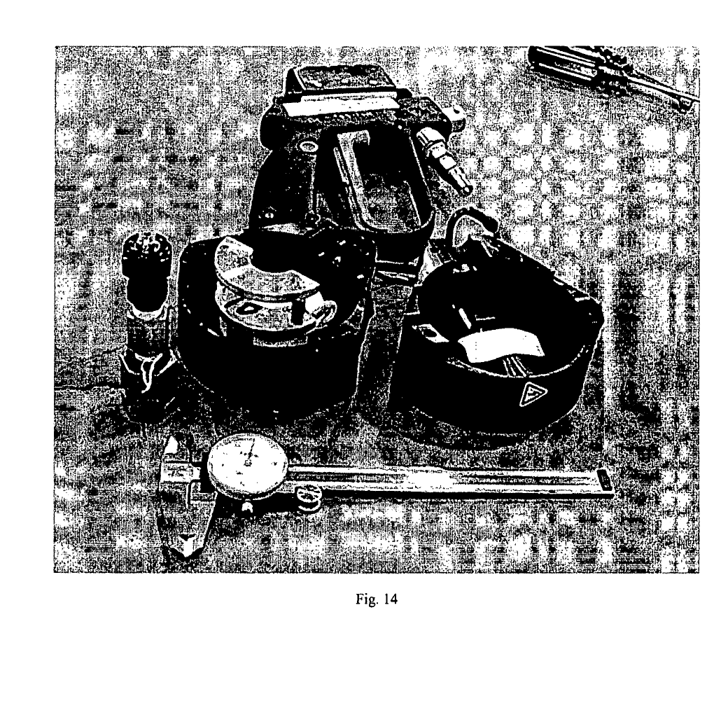

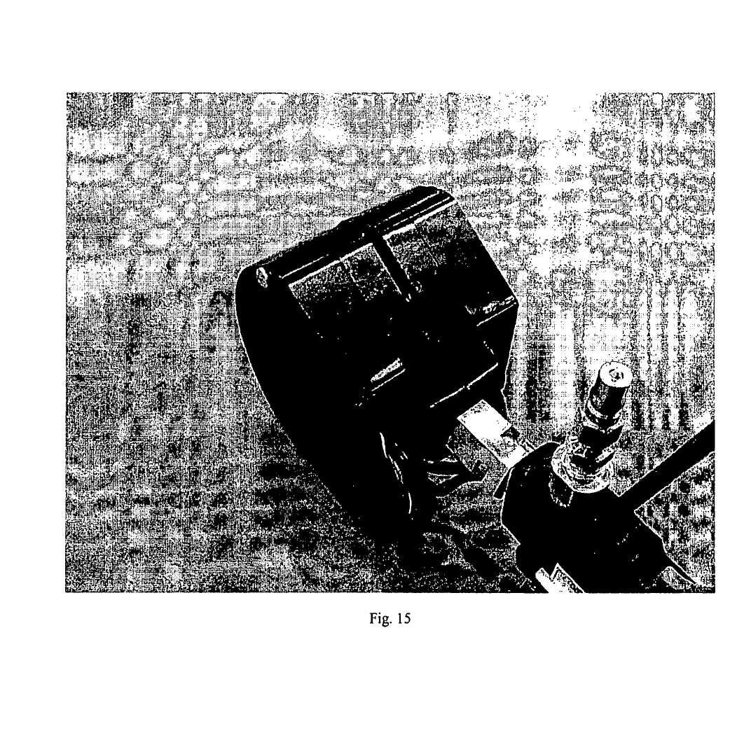

Drawings of the assembled sprayer are shown in FIG. 12. In FIG. 12a, the view is toward the exit opening through which the spray emerges. In FIG. 12b, the view shows the back of the sprayer. Shown are the housing halves 130, 132, the spray gun 161, the liquid supply connector 165, the HV power supply 171, the HV cable 145 and its connector 148, and the ground wire 143. FIG. 13 is a photograph of a prototype preferred embodiment. FIG. 14 is a photograph of the opened housing showing the interior components. The nozzle has been removed and is standing on the left. The spray gun (background) has been disconnected. Six inch calipers and some hand tools are seen for comparison of size. FIG. 15 is a photograph of the bottom side of the sprayer. The resistive tapes can be seen.

There are many useful alternative embodiments.

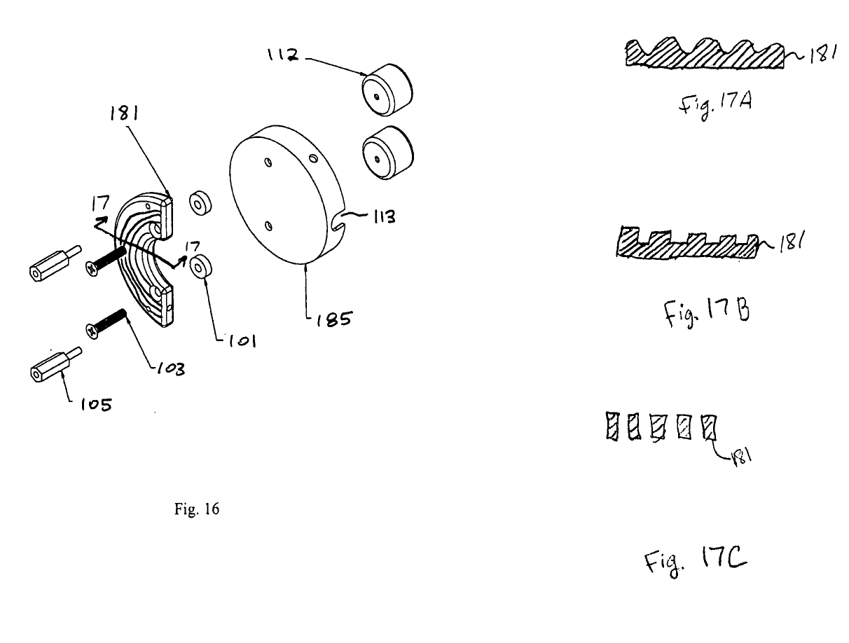

The electrodes may have advantageous surface shape or texture or have means to reduce reflections of droplets (FIG. 16). These alternative embodiments may allow more compact spacing and so more compact sprayer size, although the cost of fabrication may be greater. The electrode or electrodes may have grooves or crenelations in the surface adjacent to the principal spray to reduce the reflection of droplets from its surface (FIGS. 17A, 17B). Similarly, the electrodes may have slots or louvered construction to reduce droplet reflection (FIG. 17C), or a portion of the electrode surface may be a screen for the same purpose. In such embodiments, care must be taken to radius sharp edges to avoid arc or corona emission.

The sprayer housing with the nozzle, electrodes, and other interior components may be mounted on an easily connected and disconnected fitting, e.g., a “quick” twist motion connector, that mates to a corresponding connector on the spray gun. In this manner, the sprayer may be easily removed or attached to the spray gun. Moreover, it allows for sprayers with pre-set electrode spacings, one for positive polarity and one for negative polarity to be easily interchanged.

The electrode assembly can include threaded nuts between the concave cup and the electrode instead of or in addition to the spacer. Furthermore, electrodes can be spaced by adjustable nuts on threaded rods, By the combination of such means, the electrode spacing Δw to the principal spray can be made adjustable, and for pairs of electrodes, the centerline between the electrodes can be made to correspond to the centroid of the principal spray.

Nozzles that produce various spray patterns can be used. Alternative configurations include pencil sprays with slight divergence, e.g., a few degrees, sheet beams that are planar, hollow cone, and flat-fan, and combinations nozzles to produce a variety of spray patterns. In a preferred embodiment, flat-fan sprays with fan angle of 57 degrees and 73 degrees have been used individually and in combination.

For spray patterns that are not easily obtained with a single nozzle, multiple nozzles can be located within a common housing and may share an appropriately shaped electrode assembly or have individual electrode assemblies connected electrically. The multiple nozzles may be connected by a manifold or other means. Arrays of sprayers can be operated together.

The nozzle and sprayer ‘ground’ potential are not required to be at the same ‘ground’ potential as the target. When pairs of sprayers are used, with one spray of the pair spraying a positively charged spray, and the other spraying a negatively charged spray, the need to ground the system can be avoided. This well known technique permits aerial spraying, e.g., ‘crop dusting’ and spraying from a vehicle with insulated tires. Net charging of the vehicle or aircraft is avoided by adjusting the positive and negative sprays to be equal. The ability of the present invention to produce a spray of either polarity by selecting and adjustment of the electrode spacing to the spray enables a pair or array of sprayers to be powered by the same power supply.

In tests of the sprayer, a charge density of approximately 7 Coul/m³ is measured. In comparison the Rayleigh limit for d=500 μm droplets is 1.3 Coul/m³ and for d=100 μm, it is 12.8 Coul/m³. The larger droplets correspond to the peak of the mass distribution in droplet size. The smaller droplets correspond to the peak in the number distribution in droplet size. It is concluded that the sprayer produces a charge density that is comparable to the Rayleigh limit. In mass transfer efficiency tests, it is found that when the electrostatics are used, the sprayer typically has a transfer efficiency of approximately 85% across the operating pressure range for a sprayer to target distance of 24 inches (61 cm). When the electrostatics are not used, the transfer efficiency is less than 60%.

The new electrostatic sprayer described herein is particularly well suited for the application of photosensitizer solution to a conducting or non-conducting surface for subsequent illumination with ultraviolet light. The photosensitizer solution for such application comprises a conductive solution with a typical resistivity being of the order of 0.1 to 100 kilo-Ohm-cm, and preferably in the range 1 to 10 kilo-Ohm-cm. With the initial deposition of such a sprayed solution, the initially non-conducting object with adjacent ground connection acts as a conducting surface and the benefits of the electrostatic spraying such as the high transfer efficiency and the wraparound effect are realized.

The companies cited above are: Emco High Voltage Corporation, 11126 Ridge Road, Sutter Creek, Calif. 95685 and Spraying Systems Co., North Avenue at Schmale Road, Wheaton, Ill. 63189-7900.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. For example, the relative flow rates, size of the nozzle, electrode, etc. may all be increased or decreased to achieve the same result. Thus, the breadth and scope of the present invention should not be limited by any of the above-described exemplary embodiments, but should be defined only in accordance with the following claims appended hereto and their equivalents.

1. A method of spraying an aerosol spray, comprising:
providing a grounded nozzle and an electrode separated by a predetermined distance;
placing the electrode at a high electrical potential relative to the nozzle, thereby creating an electric field between the nozzle and the electrode;
ejecting a liquid from the nozzle towards the electrode to atomize the ejected liquid into aerosol droplets or particles, so that in the applied electric field between the nozzle and the electrode the aerosol droplets or particles obtain an induced electric charge; and
forming a directed spray of aerosol droplets or particles having a desired shape and with sufficient momentum and electric charge so that the directed spray of aerosol droplets or particles is deposited on a target.

2. The method of claim 1, further comprising
providing a cover around the nozzle and the electrode, the cover having an opening that allows a directed spray to exit, wherein the cover comprises a nonconductive material; and
grounding the cover by applying a conductive or resistive coating to at least a portion thereof and connecting the conducting or resistive coating to ground.

3. An airless electrostatic sprayer for spraying aerosol particles, comprising:
at least one electrically conductive, grounded nozzle;
a pressure source to force fluid through the nozzle wherein the exiting fluid forms a stream of aerosol particles or droplets; and
an electrode with high electric potential disposed at a distance from the nozzle and from the stream of aerosol particles or droplets, wherein the electric potential creates an electric field that charges the stream of aerosol particles or droplets;
wherein the electrode is placed sufficiently far from the stream of aerosol particles or droplets so as to induce a charge on the particles or droplets that is of the opposite polarity as the potential on the electrode.

4. The sprayer of claim 3 further comprising a cover surrounding the nozzle and electrode, wherein the cover is made of a non-conductive material that is at least partially coated with a conductive material such that the conductive material is grounded.

5. The sprayer of claim 3 wherein the electrode further comprises a plurality of grooves formed therein, wherein the grooves are perpendicular to the stream of aerosol particles or droplets, such that the grooves extend at least partially through the electrode.

6. The sprayer of claim 3 wherein the pressure source is at least one of a pump and a high-pressure vessel.

7. The sprayer of claim 3 further comprising a concave insulating cup to which the electrode is attached.

8. The sprayer of claim 3 further comprising:
a manifold to which the nozzle is mounted; and
a second electrically conductive, grounded nozzle mounted on the manifold.

9. The sprayer of claim 3 wherein the electrode comprises an annular segment of a cone.

10. The sprayer of claim 3 wherein the electrode comprises a pair of adjacent flat plates.

11. An airless electrostatic sprayer for spraying aerosol particles, comprising:
at least one electrically conductive, grounded nozzle;
a pressure source to force fluid through the nozzle wherein the exiting fluid forms a stream of aerosol particles or droplets; and
an electrode with high electric potential disposed at a distance from the nozzle and from the stream of aerosol particles or droplets, wherein the electric potential creates an electric field that charges the stream of aerosol particles or droplets;
wherein the electrode is placed sufficiently close to the stream of aerosol particles or droplets so as to induce a charge on the particles or droplets that is of the same polarity as the potential on the electrode.

12. The sprayer of claim 11 further comprising a cover surrounding the nozzle and electrode, wherein the cover is made of a non-conductive material that is at least partially coated with a conductive material such that the conductive material is grounded.

13. The sprayer of claim 11 wherein the electrode further comprises a plurality of grooves formed therein, wherein the grooves are perpendicular to the stream of aerosol particles or droplets, such that the grooves extend at least partially through the electrode.

14. The sprayer of claim 11 wherein the pressure source is at least one of a pump and a high-pressure vessel.

15. The sprayer of claim 11 further comprising a concave insulating cup to which the electrode is attached.

16. The sprayer of claim 11 further comprising:
a manifold to which the nozzle is mounted; and
a second electrically conductive, grounded nozzle mounted on the manifold.

17. The sprayer of claim 11 wherein the electrode comprises an annular segment of a cone.

18. The sprayer of claim 11 wherein the electrode comprises a pair of adjacent flat plates.
